(19) United States
(12) Patent Application Publication
(10) Pub. No.: US 2007/0258055 A1
(43) Pub. Date: Nov. 8, 2007

(54) Projection apparatus

(75) Inventors: Chun-How Shao, Miao-Li County (TW); Chia-Lun Liu, Miao-Li County (TW); Tai-Li Chang, Miao-Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/651,100

(22) Filed: Jan. 9, 2007

(30) Foreign Application Priority Data
May 5, 2006 (TW) 95116029

(51) Int. Cl. G03B 21/14

(52) U.S. Cl. 353/70

(57) ABSTRACT

A projection apparatus includes a main body and at least one movement auxiliary device disposed adjacent to the main body to help for moving the projection apparatus. By using the movement auxiliary device, a user can change the position and the projection direction of the projection apparatus easily.

### BACKGROUND OF THE INVENTION

1. Field of the Invention

The present invention relates to a projection apparatus, and more particularly, to provide a projection apparatus with at least one movement auxiliary device.

2. Description of the Prior Art

FIG. 1 is a schematic diagram of a conventional projection apparatus. A conventional projection apparatus 100 is laid on a table (not shown) by using the fixing feet 150. Users usually move (push or pull) the projection apparatus 100 by hands to change a distance between the projection apparatus 100 and a screen (not shown) to adjust an area of an image (not shown) displaying onto the screen.

Nevertheless, the projection apparatus 100 is normally not easy to move because of the large friction existed between the fixing feet 150 and the table surface. Meanwhile, if the projection apparatus 100 is a large sized model, the user needs to lift up the projection apparatus 100 completely from one position on the table and put on the proper position on the table to change a position of the projection apparatus 100. It is inconvenient for the user.

### SUMMARY OF THE INVENTION

One object of the present invention is to provide a projection apparatus, which utilizes at least one movement auxiliary device to move the projection apparatus to change a position and a projection direction of the projection apparatus easily.

Another object of the present invention is to provide a projection apparatus, which utilizes a bearing base with at least one movement auxiliary device to move the projection apparatus easily.

To achieve one, more or all purposes mentioned above, a projection apparatus according to one embodiment of the present invention includes a main body and at least one movement auxiliary device pivotally connected adjacent to the bottom of the main body to help for moving the projection apparatus.

A projection apparatus according to another embodiment of the present invention includes a main body, a bearing base to carry the main body, and at least one movement auxiliary device disposed adjacent to the bottom of the bearing base to help for moving the projection apparatus.

Other objectives, features and advantages of the present invention will be further understood from the further technology features disclosed by the present invention wherein there is shown and described a preferred embodiment of this invention, simply by way of illustration of one of the modes best suited to carry out the invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram of a conventional projection apparatus;

FIG. 2 is a schematic diagram of a projection apparatus according to a first embodiment of the present invention;

FIG. 3 is a schematic diagram of a projection apparatus according to a second embodiment of the present invention;

FIG. 4 is a schematic diagram of a projection apparatus according to a third embodiment of the present invention;

FIG. 5 is a schematic diagram of a projection apparatus according to a fourth embodiment of the present invention;

FIG. 6 is a schematic diagram of a projection apparatus according to a fifth embodiment of the present invention;

FIG. 7 is a schematic diagram of a projection apparatus according to a sixth embodiment of the present invention;

FIG. 8 is a schematic diagram of a projection apparatus according to a seventh embodiment of the present invention;

FIG. 9 is a circuit block diagram according to the projection apparatus in FIG. 8;

FIG. 10 is a decomposed schematic diagram of a projection apparatus according to an eighth embodiment of the present invention;

FIG. 11 is a side view schematic diagram according to the projection apparatus in FIG. 10; and

FIG. 12 is a side view schematic diagram of a projection apparatus according to a ninth embodiment of the present invention.

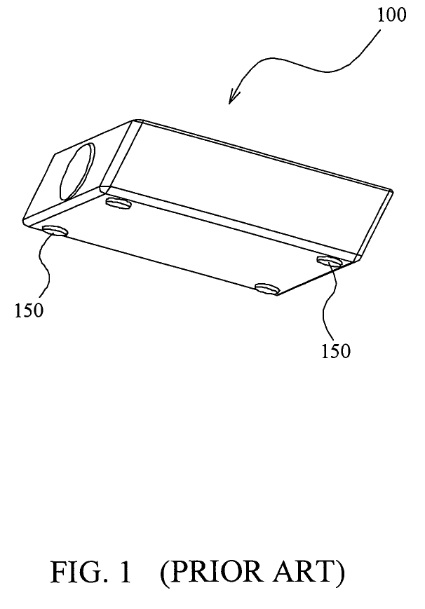

### DESCRIPTION OF THE PREFERRED EMBODIMENT

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity.

### First Embodiment

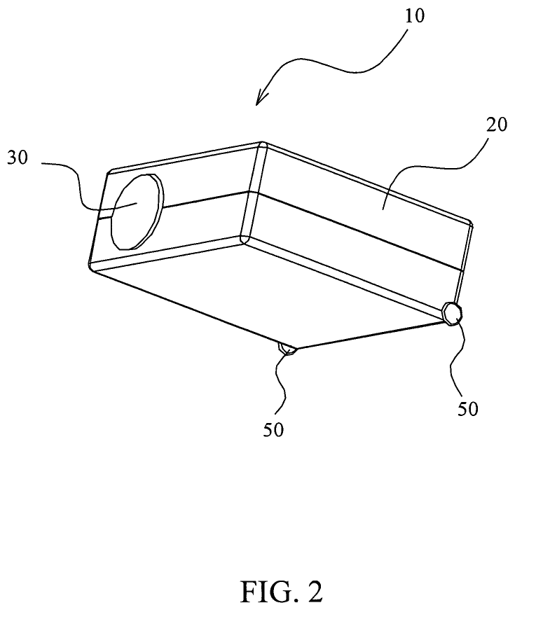

FIG. 2 is a schematic diagram of a projection apparatus according to a first embodiment of the present invention. A projection apparatus 10 includes a main body 20 and at least one movement auxiliary device 50. The main body 20 includes an illumination system (not shown in the figure), a light valve (not shown in the figure), and a projection lens 30. The illumination system provides an illumination light beam to be transformed into an image light beam by the light valve, and then the image light beam is projected by the projection lens 30 to display an image (not shown in the figure) onto, for example, a screen or a wall (not shown in the figure).

The movement auxiliary device 50 is disposed aside or adjacent to the bottom of the main body 20 to sustain the main body 20 on the table. The movement auxiliary device 50 is used to help for moving the projection apparatus 10 and adjusting a position and a projection direction of the projection apparatus 10. The movement auxiliary device 50 help for moving the projection apparatus 10 forward and backward and left and right, or in a synthesized direction which is able to be decomposed to the forward and backward components and left and right components. A distance between the projection apparatus 10 and the screen, and an area of the image are adjusted by forward and backward moving the projection apparatus 10. The relative left and right position of the image onto the screen is adjusted by left and right moving the projection apparatus 10.

The movement auxiliary device 50, which is, for example, a wheel pivot as shown in FIG. 2, a rolling wheel, a sliding wheel, or a rolling ball, is disposed aside or adjacent to the bottom of the main body 20. The projection apparatus 10 is moved to adjust the distance between the projection apparatus 10 and the screen and to adjust the area of the image by rotating or rolling the movement auxiliary device 50 according to at least one axis. The movement auxiliary device 50 can be disposed, for example, on two sides of the main body 20 of the projection apparatus 10, which are opposing to the projection lens 30, adjacent to the bottom of the main body 2 as shown in FIG. 2. Four movement auxiliary devices 50 can be respectively disposed on two sides of the front end and rear end adjacent to the bottom of the main body 20, which are preferably disposed symmetrically to increase the movement stability of the projection apparatus 10.

### Second Embodiment

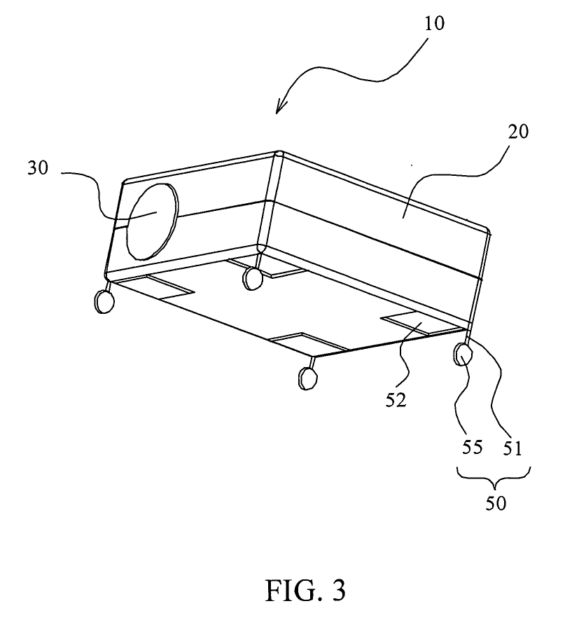

FIG. 3 is a schematic diagram of a projection apparatus according to a second embodiment of the present invention. The difference between the second embodiment and the first embodiment is that the movement auxiliary device 50 in the second embodiment has a bending portion 51 and a rolling portion 55. The rolling portion 55 is, for example, a wheel, a rolling wheel, a sliding wheel, or a rolling ball and other wheels. The main body 20 further includes at least one groove or pocket (collectively referred to as “groove”) 52, so that the rolling portion 55 can be accommodated in a groove 52 by bending the bending portion 51 when the projection apparatus 10 does not need to be moved. Alternately, at least one groove lid (not shown in the figure) can be further disposed to cover the groove 52 after the rolling portion 55 is accommodated in the groove 52, such that the projection apparatus 10 looks neat and compact.

### Third Embodiment

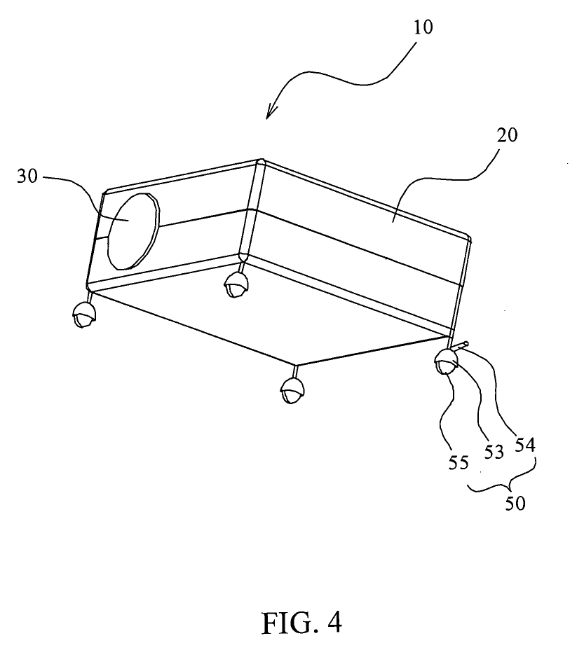

FIG. 4 is a schematic diagram of a projection apparatus according to a third embodiment of the present invention. The difference between the third embodiment and the second embodiment is that the movement auxiliary device 50 in the third embodiment further includes a fender 53 disposed between the bending portion 51 and the rolling portion 55 to prevent the dust from spreading into a pivotal connection part of the rolling portion 55. Otherwise the dust accumulated day by day makes the rolling portion 55 difficultly to roll. Alternately, the movement auxiliary device 50 further includes a position element 54 to fix the position of the projection apparatus 10 after the projection apparatus 10 is moved to a desired place. The position element 54 can prevent the projection apparatus 10 from sliding. The positioning element 54 is, for example, a brake element, which the rolling portion 55 is locked to an unmovable mode by pushing downward the positioning element 54.

### Fourth Embodiment

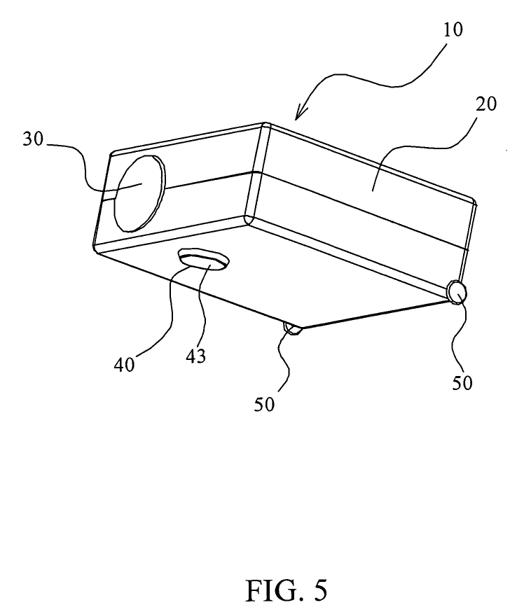

FIG. 5 is a schematic diagram of a projection apparatus according to a fourth embodiment of the present invention. The difference between the fourth embodiment and the first embodiment is that the projection apparatus 10 further includes an angle adjusting device 40, which is disposed adjacent to one end of the bottom portion of the main body 20 adjacent to the projection lens 30, to adjust the projection angle of the projection lens 30. The angle adjusting device 40 includes a supporting portion 43 and a mechanism disposed between the supporting portion 43 and the main body 20 that can be screwed into the main body 20, such as a screw or a lengthening and shortening tube (not shown in the figure).

### Fifth Embodiment

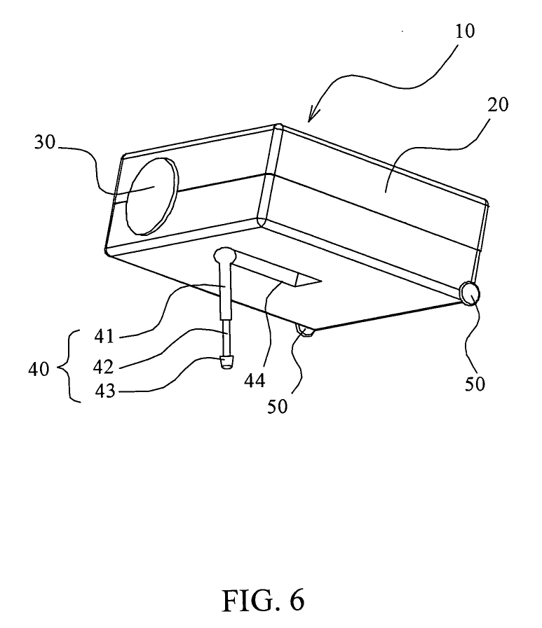

Please refer to the FIG. 6 for a fifth embodiment of the present invention, the angle adjusting device 40 protrudes from the main body 20. The angle adjusting device 40 can be lengthened or shortened to adjust the height of the main body 20 relative to the table which the projection apparatus 10 is positioned thereon and accommodated in a groove 44 of the main body 20. The action for lengthening, shortening, and accommodating can be done manually or electrically. The angle adjusting device 40 in this embodiment includes an angle-adjusting main body 41, a length adjusting portion 42, and a supporting portion 43. The angle-adjusting main body 41 is connected to the main body 20 and the supporting portion 43 is touched with the table surface. The length adjusting portion 42 is disposed between the angle-adjusting main body 41 and the supporting portion 43 for length adjustment and thus adjusting the height of the main body 20 relative to the table which the projection apparatus 10 is positioned thereon. Therefore, the image can be moved up and down by adjusting the angle adjusting device 40.

### Sixth Embodiment

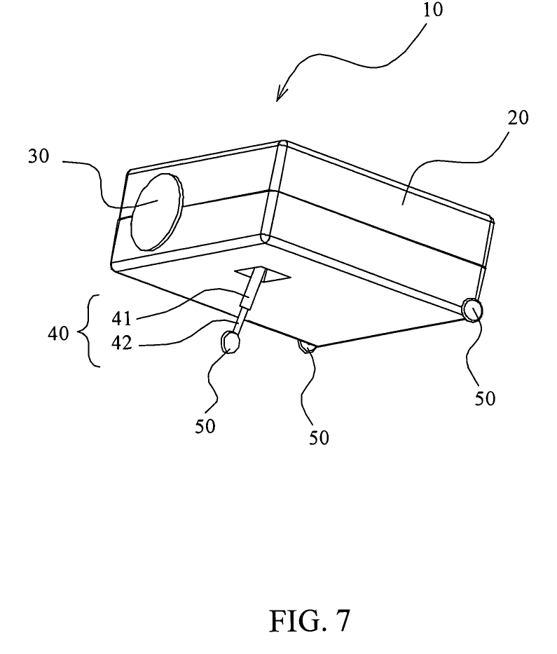

Please refer to the FIG. 7 for a sixth embodiment of the present invention, a movement auxiliary device 50, such as a rotating wheel or a rolling wheel, is disposed at the end of the angle adjusting device 40 to replace the supporting portion 43 illustrated in FIG. 6. The angle adjusting device 40 includes an angle-adjusting main body 41 and a length adjusting portion 42, such as a screw. The length adjusting portion 42 is able to be lengthened or shortened to adjust the height of the projection lens 30 relative to the table which the projection apparatus 10 is positioned thereon when moving the projection apparatus 10. The movement auxiliary device 50 connected to the angle adjusting device 40 can roll or rotate to forward and backward or left and right to move the projection apparatus 10. Therefore, the projection apparatus 10 may further satisfy the user's demand of moving the projection apparatus multi directionally.

### Seventh Embodiment

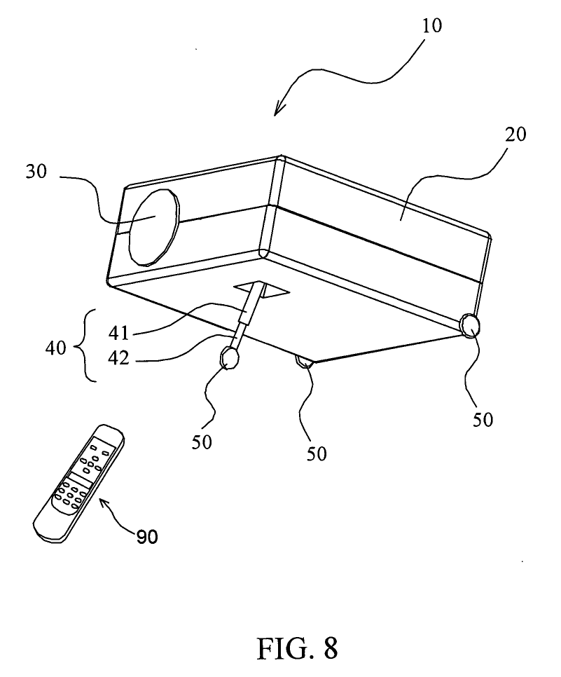

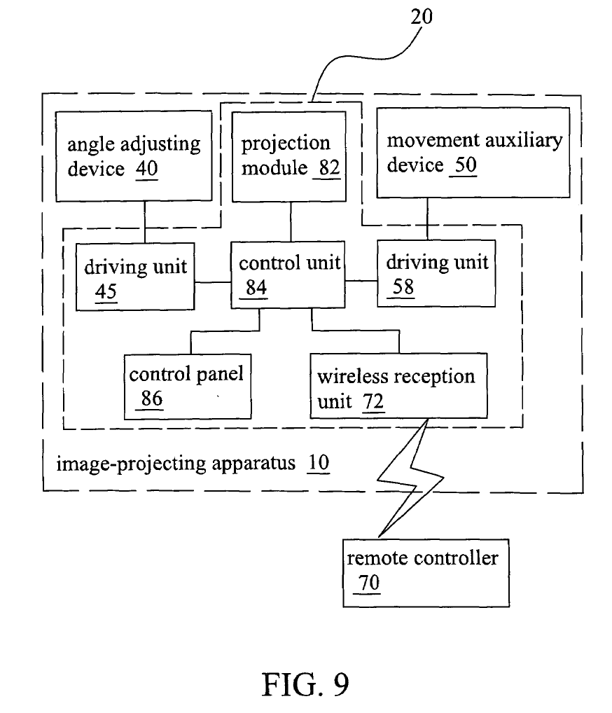

Please refer to the FIG. 8 for a seventh embodiment of the present invention, a remote controller 90 is used to remotely adjust the angle adjusting device 40 and the movement auxiliary device 50 when they are driven electrically. Please refer to the FIG. 9. The main body 20 includes a projection module 82, a control unit 84, two driving units 45-58, a control panel 86, and a wireless reception unit 72. The projection module 82 is used to provide an image, and the control unit 84 is used to control the operation of each unit. The control panel 86 is used to receive commands inputted from outside, and the wireless reception unit 72 is used to receive wireless signals transmitted from the remote controller 70. The control unit 84 transmits driving signals to the driving units 45 and 58 after receiving the commands from the control panel 86 or from the wireless reception unit 72. Then, the driving units 45 and 58 respectively drive the angle adjusting device 40 and the movement auxiliary device 50 after receiving the driving signals from the control unit 84, thus the projection apparatus 10 can be moved to the desired place for the user.

### Eighth Embodiment

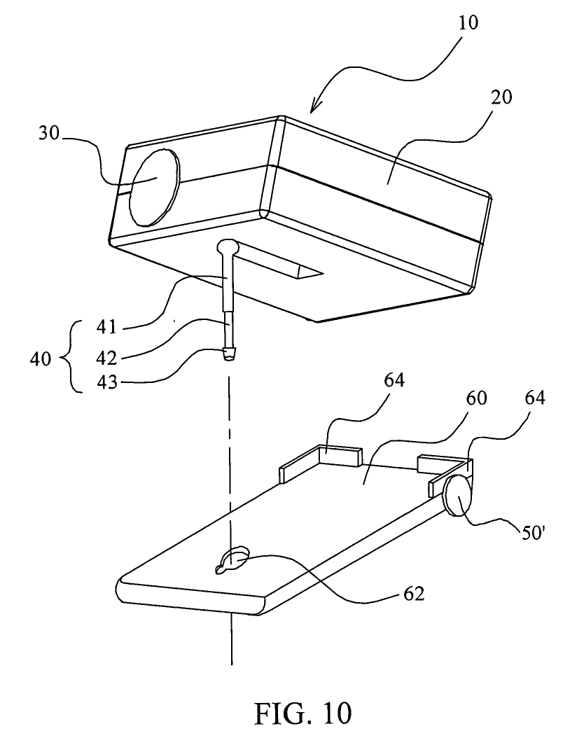

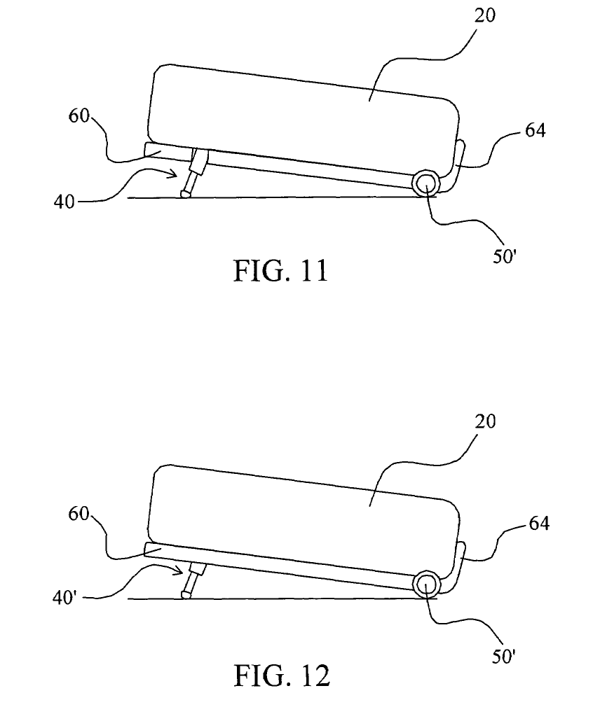

FIG. 10 and FIG. 11 are the decomposed and side views of a projection apparatus respectively according to an eighth embodiment of the present invention. The projection apparatus 10 includes a main body 20 having a projection lens 30, an angle adjusting device 40, a bearing base 60, and at least one movement auxiliary device 50′. The angle adjusting device 40 is disposed at the bottom of the main body 20 to adjust the projection angle of the projection lens 30. The bearing base 60 is used to carry the main body 20, and the movement auxiliary device 50′ is disposed adjacent to the bottom of the bearing base 60 to facilitate moving the projection apparatus 10. The bearing base 60 has an opening 62 provided for the angle adjusting device 40 to pass through. In the embodiment, the movement auxiliary device 50′ is, for example, a wheel as shown in FIG. 10 or a rolling ball. The bearing base 60 further includes a back prop 64 to be against the main body 20 to prevent the main body from sliding back. The embodiment of the present invention can overcome the difficulty of movement in the conventional projection apparatus having no movement auxiliary design, by just supplementing the bearing base 60 with the movement auxiliary device 50′.

In this embodiment, the main body 20 is placed on the bearing base 60. The angle adjusting device 40 is disposed at the main body 20, while the movement auxiliary device 50′ is disposed at the bearing base 60. Please refer to the FIG. 12 for a ninth embodiment of the present invention, both angle adjusting device 40′ and the movement auxiliary device 50′ are disposed at the bearing base 60.

Accordingly, some embodiments of present invention combines the angle adjusting device and the movement auxiliary device to facilitate adjusting the projection angle of the projection lens as well as moving the projection apparatus forward and backward and left and right on the table. Therefore, it is very easy to move (push or pull) the projection apparatus to change the position and the projection direction of the projection apparatus by applying the movement auxiliary device of the present invention, even the projection apparatus is a large sized model.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It is intended that the scope of the invention be defined by the Claims appended hereto and their equivalents. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. Moreover, no element and component in the present disclosure is intended to be dedicated to the public regardless of whether the element or component is explicitly recited in the following claims.

What is claimed is:

1. A projection apparatus, comprising:
a main body to provide an image light beam; and
at least one movement auxiliary device pivotally connected adjacent to the bottom of said main body for facilitating moving said projection apparatus.

2. The projection apparatus according to claim 1, wherein said movement auxiliary device facilitates moving the projection apparatus forward and backward and left and right on a table.

3. The projection apparatus according to claim 1, wherein said movement auxiliary device rotates or rolls with respect to at least one axis relative to said main body.

4. The projection apparatus according to claim 1, wherein said movement auxiliary device is selected from a group consisting of a wheel and a rolling ball.

5. The projection apparatus according to claim 1, wherein said movement auxiliary device is disposed symmetrically adjacent to the bottom of said main body.

6. The projection apparatus according to claim 1, wherein said movement auxiliary device comprises a bending portion and a rolling portion, said bending portion is disposed between said rolling portion and said main body, and said main body comprises at least one groove to accommodate said movement auxiliary device.

7. The projection apparatus according to claim 6, wherein said movement auxiliary device further comprises a fender disposed between said bending portion and said rolling portion.

8. The projection apparatus according to claim 1, wherein said movement auxiliary device further comprises a positioning element.

9. The projection apparatus according to claim 1, wherein said main body comprises:
an illumination system;
a light valve; and
a projection lens, wherein said illumination system provides an illumination light beam transformed into said image light beam by said light valve, and said image light beam is projected by said projection lens to display an image onto a screen.

10. The projection apparatus according to claim 1, further comprising an angle adjusting device disposed at the bottom of said main body to adjust the projection angle of said main body.

11. The projection apparatus according to claim 1, wherein said main body comprises:
a projection module used to provide said image light beam;
a control unit;
a driving unit electrically coupled to said movement auxiliary device;
a control panel; and
a wireless reception unit, wherein said control unit is used to control the operation of said projection module and driving unit, said control panel and said wireless reception unit are used to receive a command from outside and transmit said command to said control unit, and said control unit transmits signals to said driving unit to control the operation of said movement auxiliary device after receiving said command.

12. A projection apparatus, comprising:
a main body to provide an image light beam;
a bearing base to carry said main body; and
at least one movement auxiliary device disposed adjacent to the bottom of said bearing base to facilitating moving said projection apparatus.

13. The projection apparatus according to claim 12, wherein said movement auxiliary device is pivotally connected adjacent to the bottom of said bearing base, and said movement auxiliary device is selected from a group consisting of a wheel and a rolling ball.

14. The projection apparatus according to claim 12, further comprising an angle adjusting device disposed at the bottom of said main body to adjust the projection angle of said main body.

15. The projection apparatus according to claim 14, wherein said bearing base has an opening provided for the angle adjusting device to pass through.

16. The projection apparatus according to claim 12, further comprising an angle adjusting device disposed at the bottom of said bearing base to adjust the projection angle of said main body.
